(19) United States
(12) Patent Application Publication
(10) Pub. No.: US 2011/0110442 A1
(43) Pub. Date: May 12, 2011

(54) Systems, Devices, And Methods For Generating Pilot Patterns For Use In Communications

(75) Inventors: Jia-Hao Wu, Guishan Township (TW); Yu-Tao Hsien, Hsinchu City (TW); Pang-An Ting, Fengyuan City (TW)

(73) Assignee: Industrial Technology Research Institute

(21) Appl. No.: 12/874,758

(22) Filed: Sep. 2, 2010

Related U.S. Application Data
(60) Provisional application No. 61/259,689, filed on Nov. 10, 2009.

(51) Int. Cl. H04L 27/28

(52) U.S. Cl. 375/260

(57) ABSTRACT

A computer-implemented method for generating a pilot pattern for use in an orthogonal frequency-division multiplexing (OFDM) based communication system. The method includes: generating a basic resource unit to which a plurality of pilot symbols are allocated, each of the pilot symbols corresponding to a subcarrier frequency and an OFDM symbol; deriving one or more variant resource units from the basic resource unit; and combining ones of the basic resource unit and the one or more variant resource units to generate a resource block including the pilot pattern.

### RELATED APPLICATIONS

This application is based upon and claims the benefit of priority from U.S. Provisional Patent Application No. 61/259,689, filed Nov. 10, 2009, the entire contents of which are incorporated herein by reference.

### TECHNICAL FIELD

This disclosure relates to systems, devices, and methods for generating pilot patterns for use in communications.

### BACKGROUND

Wireless communication techniques based on multiple subcarriers, such as an orthogonal frequency-division multiplexing (OFDM) technique or a discrete multi-tone transmission (DMT) technique, are gaining worldwide popularity due to their broad applications. For example, an OFDM based communication system may be used in a plurality of networks including Worldwide Interoperability for Microwave Access (WiMax) networks, Wireless Fidelity (Wi-Fi) networks, Wireless Broadband (WiBro) networks, etc.

The OFDM technique uses a plurality of closely-spaced orthogonal subcarriers to carry data. For example, the data may be allocated on a plurality of parallel data channels, one for each of the subcarriers. Each of the subcarriers may be modulated with a conventional modulation scheme, e.g., quadrature amplitude modulation, at a relatively low symbol rate. In addition, based on the OFDM technique, an inverse fast Fourier transform (IFFT) may be performed on OFDM symbols representing the data on a transmitter side of the OFDM based communication system, and a fast Fourier transform (FFT) may be performed to recover the OFDM symbols on a receiver side of the OFDM based communication system. Signals including the OFDM symbols are transmitted from the transmitter side to the receiver side through a communication channel.

The communication channel may have an effect on the signals when the signals are transmitted. The receiver side may need knowledge of the communication channel to remove such effect, in order to accurately recover the data. To facilitate estimation of the communication channel, pilot signals known to both the transmitter side and the receiver side may be inserted in OFDM symbols on the transmitter side. The receiver side may perform channel estimation based on resource blocks in received signals, and each of the resource blocks includes a plurality of OFDM symbols and, hence, pilot symbols.

For the OFDM based communication system, the communication channel may be highly frequency selective due to multipath delay spread. Furthermore, mobility of the receiver side may also result in rapid change in channel condition. Accordingly, it may be desirable to generate pilot patterns providing good channel estimation capability.

### SUMMARY

According to a first aspect of the present disclosure, there is provided a computer-implemented method for generating a pilot pattern for use in an orthogonal frequency-division multiplexing (OFDM) based communication system, the method comprising: generating a basic resource unit to which a plurality of pilot symbols are allocated, each of the pilot symbols corresponding to a subcarrier frequency and an OFDM symbol; deriving one or more variant resource units from the basic resource unit; and combining ones of the basic resource unit and the one or more variant resource units to generate a resource block including the pilot pattern.

According to a second aspect of the present disclosure, there is provided a computer-implemented method for generating first and second pilot patterns for use in an orthogonal frequency-division multiplexing (OFDM) based communication system, the method comprising: generating a basic resource unit to which a plurality of pilot symbols are allocated, each of the pilot symbols corresponding to a subcarrier frequency and an OFDM symbol; deriving one or more variant resource units from the basic resource unit; combining ones of the basic resource unit and the one or more variant resource units to generate a first resource block including the first pilot pattern; and combining ones of the basic resource unit and the one or more variant resource units to generate a second resource block including the second pilot pattern.

According to a third aspect of the present disclosure, there is provided a computer-implemented method for generating a pilot pattern for use in an orthogonal frequency-division multiplexing (OFDM) based communication system, the method comprising: determining locations of pilot symbols in a resource block including the pilot pattern, such that a sum of channel estimation mean square errors (MSEs) at all data symbols in the resource block is minimized.

According to a fourth aspect of the present disclosure, there is provided a computer-implemented method for generating a pilot pattern for use in an orthogonal frequency-division multiplexing (OFDM) based communication system, the method comprising: determining locations of pilot symbols in a resource block including the pilot pattern, such that a sum of norm squares of channel correlation vectors may be maximized, wherein each of the channel correlation vectors represents channel correlations between one data symbol and a plurality of pilot symbols for a data stream.

According to a fifth aspect of the present disclosure, there is provided a method for a base station to adapt a new pilot pattern, the method comprising: transmitting, to a mobile station, data including a current pilot pattern; receiving, from the mobile station, a pilot pattern index determined by the mobile station, wherein the mobile station determines the pilot pattern index by estimating a channel condition between the base station and the mobile station; and determining the new pilot pattern based on the received pilot pattern index.

According to a sixth aspect of the present disclosure, there is provided a base station, comprising: a set of antennas configured to transmit, to a mobile station, data including a current pilot pattern, and to receive, from the mobile station, a pilot pattern index determined by the mobile station, wherein the mobile station determines the pilot pattern index by estimating a channel condition between the base station and the mobile station; and a processor configured to determine a new pilot pattern based on the received pilot pattern index.

According to a seventh aspect of the present disclosure, there is provided a method for a mobile station to assist a base station to adapt a new pilot pattern, comprising: receiving, from the base station, data including a current pilot pattern; estimating a channel condition including a Doppler frequency or a delay spread between the base station and the mobile station, based on the current pilot pattern; determining an index for a new pilot pattern based on the estimated channel condition; and transmitting the index for the new pilot pattern to the base station in order for the base station to adapt the new pilot pattern.

According to an eighth aspect of the present disclosure, there is provided a mobile station, comprising: a set of antennas configured to receive from a base station data including a current pilot pattern; and a processor configured to estimate a channel condition including a Doppler frequency or a delay spread between the base station and the mobile station, based on the current pilot pattern, and to determine an index for a new pilot pattern based on the estimated channel condition; wherein the set of antennas is further configured to transmit the index for the new pilot pattern to the base station in order for the base station to adapt the new pilot pattern.

According to a ninth aspect of the present disclosure, there is provided a base station for generating a pilot pattern for use in an orthogonal frequency-division multiplexing (OFDM) based communication system, the base station comprising: a processor, the processor being configured to: generate a basic resource unit to which a plurality of pilot symbols are allocated, each of the pilot symbols corresponding to a subcarrier frequency and an OFDM symbol; derive one or more variant resource units from the basic resource unit; and combine ones of the basic resource unit and the one or more variant resource units to generate a resource block including the pilot pattern.

According to a tenth aspect of the present disclosure, there is provided a base station for generating first and second pilot patterns for use in an orthogonal frequency-division multiplexing (OFDM) based communication system, the base station comprising: a processor, the processor being configured to: generate a basic resource unit to which a plurality of pilot symbols are allocated, each of the pilot symbols corresponding to a subcarrier frequency and an OFDM symbol; derive one or more variant resource units from the basic resource unit; combine ones of the basic resource unit and the one or more variant resource units to generate a first resource block including the first pilot pattern; and combine ones of the basic resource unit and the one or more variant resource units to generate a second resource block including the second pilot pattern.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and, together with the description, serve to explain the principles of the invention.

FIG. 1 shows a generated pilot pattern included in a resource block, according to an exemplary embodiment.

FIG. 2 illustrates a flowchart of a method for generating one or more pilot patterns for use in an OFDM based communication system, according to an exemplary embodiment.

FIGS. 3A-3E illustrate an example of generating a first pilot pattern and a second pilot pattern, according to an exemplary embodiment.

FIGS. 4A-4F illustrate an example of generating a pilot pattern, according to an exemplary embodiment.

FIGS. 5A and 5B illustrate a method for adjusting locations of pilot symbols close to a border between a basic resource unit and a variant resource unit, according to an exemplary embodiment.

FIG. 6 illustrates a method for generating a pilot pattern for use in an OFDM based communication system, according to an exemplary embodiment.

FIG. 7 illustrates a flowchart of a method for an OFDM based communication system to adapt a new pilot pattern during communications, according to an exemplary embodiment.

FIG. 8 illustrates a block diagram of a base station, according to an exemplary embodiment.

FIG. 9 illustrates a block diagram of a mobile station, according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of systems, devices and methods consistent with aspects related to the invention as recited in the appended claims.

In exemplary embodiments, there are provided systems, devices, and methods for generating pilot patterns for use in a wireless communication system. For illustrative purposes only, for embodiments disclosed herein, it is assumed that the communication system is an orthogonal frequency-division multiplexing (OFDM) based communication system transmitting first and second data streams.

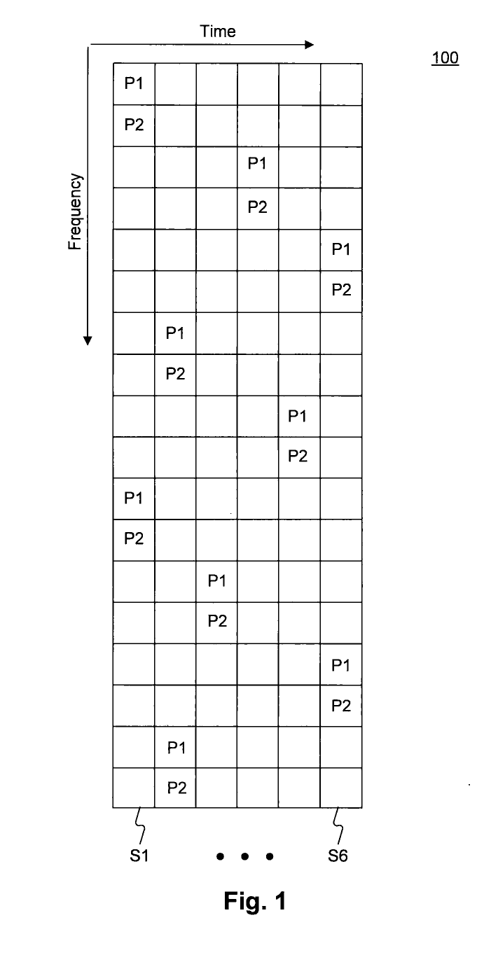

FIG. 1 shows a generated pilot pattern included in a resource block 100, according to an exemplary embodiment. For example, a resource block may be a representation including a plurality of contiguous OFDM symbols shown in a time-frequency domain. Each row of the resource block 100 corresponds to a subcarrier frequency of the communication system, and each column of the resource block 100 corresponds to an OFDM symbol. The resource block 100 includes a plurality of OFDM symbols such as OFDM symbols S1, . . . , S6, which further include a plurality of data symbols (not shown) each corresponding to a small blank block and a plurality of pilot symbols each represented by a small block with an indexed letter P. For example, the small blocks with indexed letters “P1” and “P2” represent pilot symbols for first and second data streams, respectively. In the resource block 100, each of the OFDM symbols S1, . . . , S6 is composed of one of the columns of data symbols and any pilot symbols included therein. A size of the resource block 100 may be defined by two parameters: (1) a number of subcarrier frequencies in the resource block 100, i.e., a number of rows of the resource block 100, and (2) a number of OFDM symbols in the resource block 100, i.e., a number of columns of the resource block 100. For example, in the illustrated embodiment, the size of the resource block 100 is 18 subcarrier frequencies×6 OFDM symbols, where “×” is a symbol for expressing the two parameters.

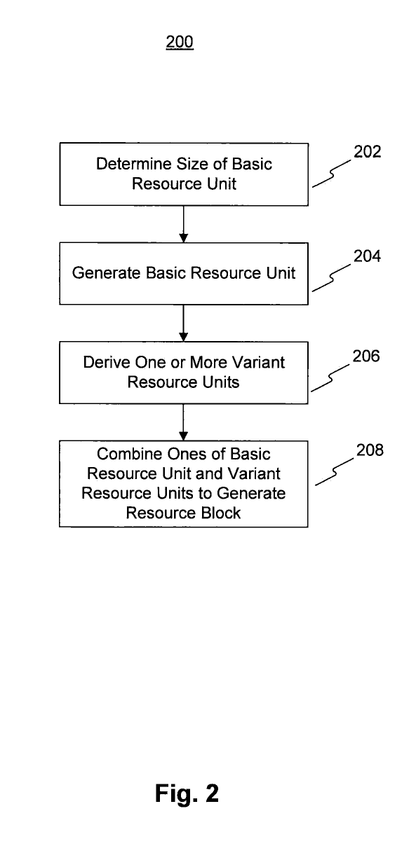

FIG. 2 illustrates a flowchart of a method 200 for generating one or more pilot patterns, such as the pilot pattern included in the resource block 100 (FIG. 1), for use in the above noted OFDM based communication system, according to an exemplary embodiment. Referring to FIG. 2, a size of a basic resource unit is determined (202). In the exemplary embodiments, a size of a basic resource unit may be defined as a number of subcarrier frequencies in the basic resource unit ×a number of OFDM symbols in the basic resource unit.

In exemplary embodiments, one pilot pattern needs to be generated, and the pilot pattern is included in a resource block with a first number of subcarrier frequencies×a second number of OFDM symbols. Accordingly, a size of the basic resource unit may be determined to be N1 subcarrier frequencies×N2 OFDM symbols, where N1 is a factor of the first number, and N2 is a factor of the second number. As used herein, the term “factor” is defined as follows: if a number can be expressed as a product of first and second integers, the first and second integers are each a factor of that number.

In one exemplary embodiment, the pilot pattern included in the resource block 100 (FIG. 1) is to be generated. Because the size of the resource block 100 is 18 subcarrier frequencies×6 OFDM symbols, the size of the basic resource unit may be determined to be 6 (a factor of 18) subcarrier frequencies×6 (a factor of 6) OFDM symbols, or 9 (a factor of 18) subcarrier frequencies×2 (a factor of 6) OFDM symbols, etc.

In exemplary embodiments, a plurality of pilot patterns, e.g., first and second pilot patterns, need to be generated. The first pilot pattern is included in a first resource block with a first number of subcarrier frequencies×a second number of OFDM symbols, and the second pilot pattern is included in a second resource block with a third number of subcarrier frequencies×a fourth number of OFDM symbols. Accordingly, a size of the basic resource unit may be determined to be N3 subcarrier frequencies×N4 OFDM symbols, where N3 is a common factor of the first number and the third number, and N4 is a common factor of the second number and the fourth number.

In one exemplary embodiment, the first pilot pattern is included in a resource block with a size of 18 subcarrier frequencies×6 OFDM symbols, and the second pilot pattern is included in a resource block with a size of 12 subcarrier frequencies×12 OFDM symbols. Accordingly, the size of the basic resource unit may be determined to be 6 (a common factor of 18 and 12) subcarrier frequencies×6 (a common factor of 6 and 12) OFDM symbols.

In exemplary embodiments, after the size of the basic resource unit is determined, pilot symbols may be allocated to generate the basic resource unit (204). The allocation of pilot symbols may be based on a predetermined pilot overhead constraint. On one hand, pilot symbols typically do not carry information that the transmitter side intends to transmit to the receiver side and, hence, may cause communication overhead. On the other hand, an increased number of pilot symbols inserted in OFDM symbols may be beneficial to improve accuracy of channel estimation. For example, for a pilot pattern for two data streams included in a resource block with a predetermined pilot overhead of 16.7%, a maximum of six pilot symbols may be allocated to the 6×6 basic resource unit noted above.

In addition, frequency spacing of pilot symbols for a data stream may be set relatively small to provide good interpolation for a frequency-selective channel. Additionally, the pilot symbols are allocated to the basic resource unit to form a plurality of pilot clusters, each of the pilot clusters including a first pilot symbol P1 and a second pilot symbol P2 for the first data stream and the second data stream, respectively. For example, the first and second pilot symbols P1 and P2 may be respectively allocated to adjacent subcarrier frequencies of the communication system in one OFDM symbol, and/or be allocated to a same subcarrier frequency of the communication system in adjacent OFDM symbols. As a result, the basic resource unit is generated.

In exemplary embodiments, after the basic resource unit is generated, one or more additional resource units, referred to herein as variant resource units, may be derived from the basic resource unit (206). For example, a variant resource unit may be derived by interchanging positions of the first and second pilot symbols P1 and P2 in the basic resource unit within a cluster. Also for example, a variant basic resource unit may be derived through a mirroring operation by moving a pilot symbol from a first location in the basic resource unit to a second location in the basic resource unit, the first and second locations being symmetrical in time or in frequency. Further for example, a variant resource unit may be derived by performing, in time or in frequency, a cyclic shift of pilot symbols in the basic resource unit. As another example, a variant resource unit may be derived by performing a rotational shift of pilot symbols in the basic resource unit with respect to a center of the basic resource unit. As another example, a variant resource unit may be derived by using the basic resource unit as the variant resource unit. These deriving operations generally do not change pilot overhead.

In exemplary embodiments, two or more of the above deriving operations may be used together to derive a variant resource unit. In addition, a first variant resource unit may also be combined with the basic resource unit or a second variant resource unit to form a new variant resource unit. These operations to derive variant resource units are described in more detail below.

In exemplary embodiments, after the basic resource unit is generated and the one or more variant resource units are derived, ones of the basic resource unit and the variant resource units may be combined to generate one or more resource blocks each including a pilot pattern (208). The combination may be along the time axis or the frequency axis.

In addition, in some embodiments, a generated resource block may be further modified. For example, after the resource block is generated by combining a basic resource unit and a variant resource unit, a location of a pilot symbol close to a border between the basic resource unit and the variant resource unit may be further adjusted after the combination, as described below.

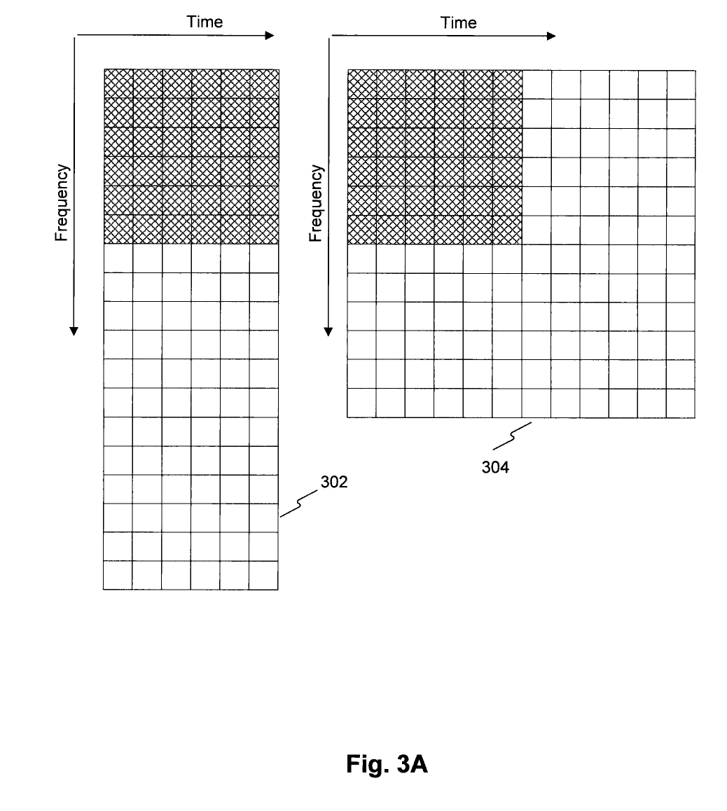

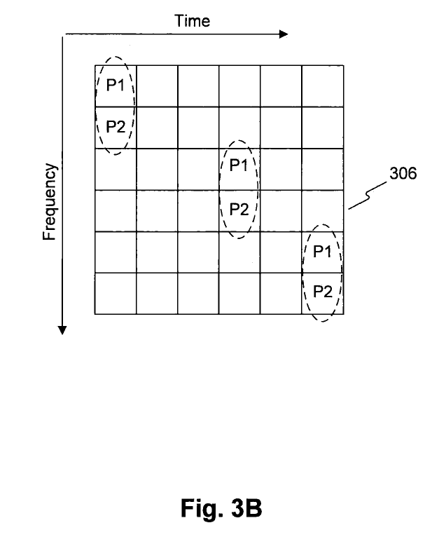

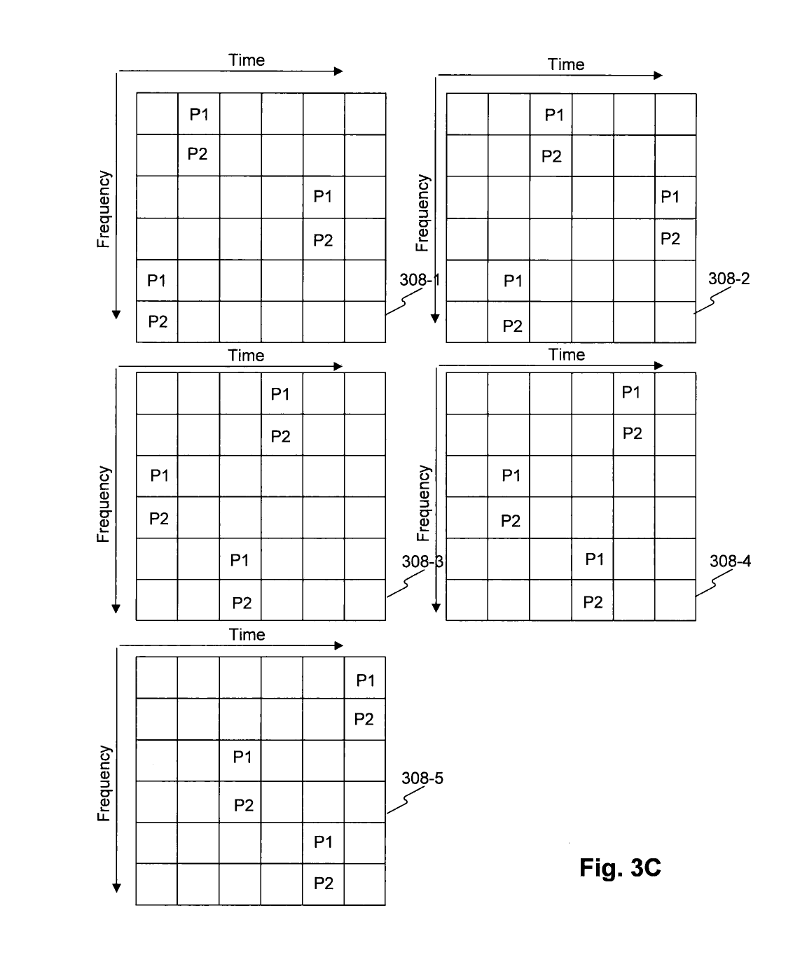

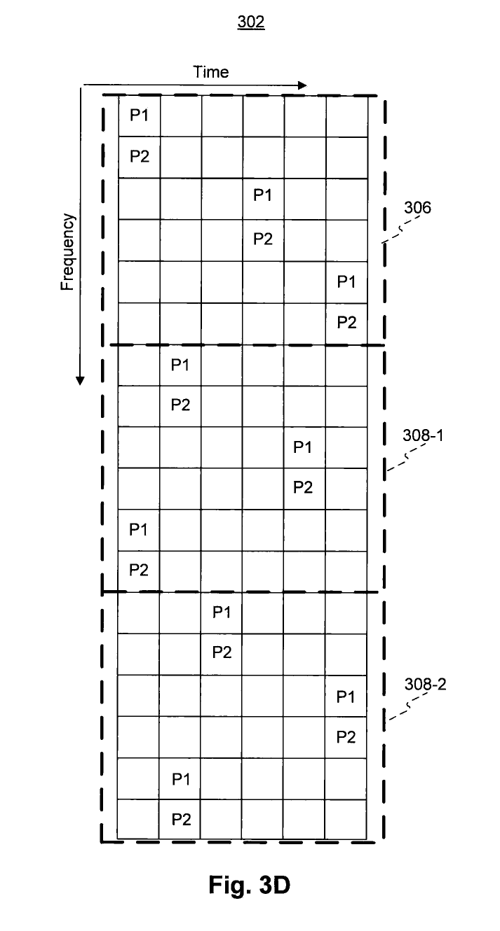

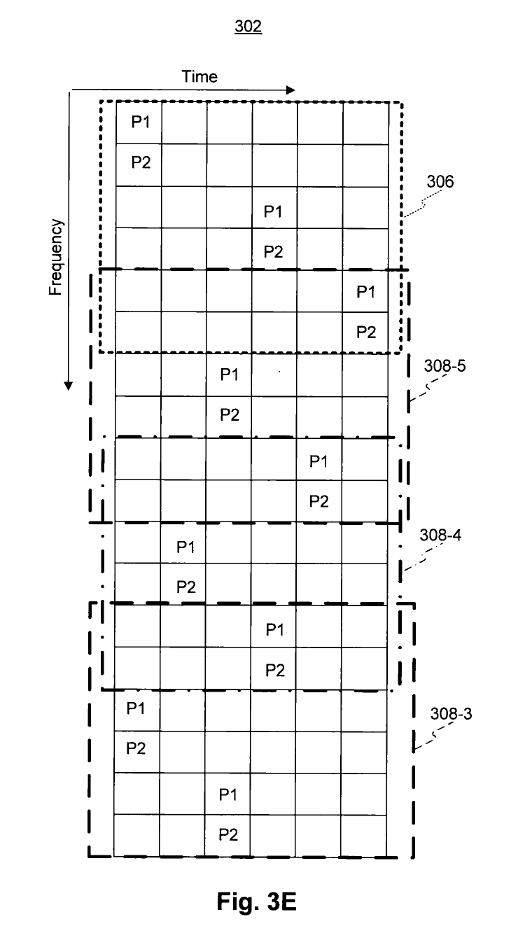

FIGS. 3A-3E illustrate an example of generating a first pilot pattern and a second pilot pattern using the method 200 (FIG. 2), according to an exemplary embodiment. For example, the first pilot pattern and the second pilot pattern are included in a first resource block 302 and a second resource block 304, respectively, and may both be used in the above noted OFDM based communication system.

Referring to FIG. 3A, in the exemplary embodiment, the first resource block 302 has a size of 18 subcarrier frequencies×6 OFDM symbols, and the second resource block 304 has a size of 12 subcarrier frequencies×12 OFDM symbols. Accordingly, a size of a basic resource unit for the first resource block 302 and the second resource block 304 may be determined to be 6 subcarrier frequencies×6 OFDM symbols (FIG. 2, step 202), as shown by the shaded areas in FIG. 3A.

More particularly, for the number of the subcarrier frequencies in the basic resource unit, 6 is a common factor of the number of subcarrier frequencies in the first resource block 302, i.e., 18, and the number of subcarrier frequencies in the second resource block 304, i.e., 12. For the number of the OFDM symbols in the basic resource unit, 6 is a common factor of the number of OFDM symbols in the first resource block 302, i.e., 12, and the number of OFDM symbols in the second resource block 304, i.e., 12.

FIG. 3B shows a generated basic resource unit 306 with the determined size of 6 subcarrier frequencies×6 OFDM symbols, according to an exemplary embodiment. For example, pilot symbols are allocated to the basic resource unit 306 to form a plurality of pilot clusters each encircled by a dashed line in FIG. 3B. Each of the pilot clusters includes a first pilot symbol P1 and a second pilot symbol P2 for the first data stream and the second data stream, respectively. As noted above, the allocation of the pilot symbols may be based on a predetermined pilot overhead constraint. As a result, the basic resource unit 306 is generated (FIG. 2, step 204).

Next, one or more variant resource units may be derived from the basic resource unit 306 (FIG. 2, step 206). For example, FIG. 3C shows exemplary variant resource units 308-1, 308-2, . . . , 308-5 derived from the basic resource unit 306. The variant resource units 308-1, 308-2, . . . , 308-5 are each derived by performing, in time, a cyclic shift of the pilot symbols in the basic resource unit 306.

In exemplary embodiments, the first resource block 302 including the first pilot pattern may then be generated by combining ones of the basic resource unit 306 and the variant resource units 308-1, 308-2, . . . , 308-5 (FIG. 2, step 208). For example, the first resource block 302 may be generated by cascading, in frequency, the basic resource unit 306, the variant resource unit 308-1, and the variant resource unit 308-2, as shown in FIG. 3D.

Also for example, the first resource block 302 including the first pilot pattern may be generated by cascading, in frequency, the basic resource unit 306, the variant resource unit 308-3, the variant resource unit 308-4, and the variant resource unit 308-5, as shown in FIG. 3E. In this combination, there is overlapping between the basic resource unit 306 and the variant resource unit 308-5, and between the variant resource units 308-3, 308-4, and 308-5.

Similar to the above description, the second resource block 304 including the second pilot pattern may be generated (not shown).

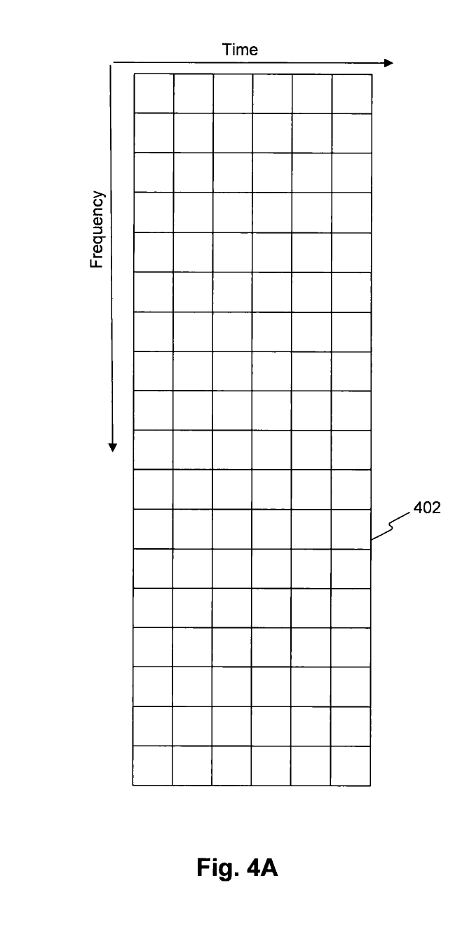

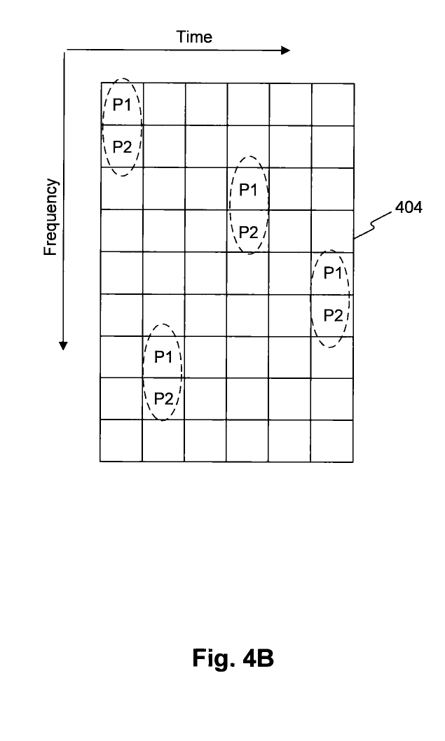

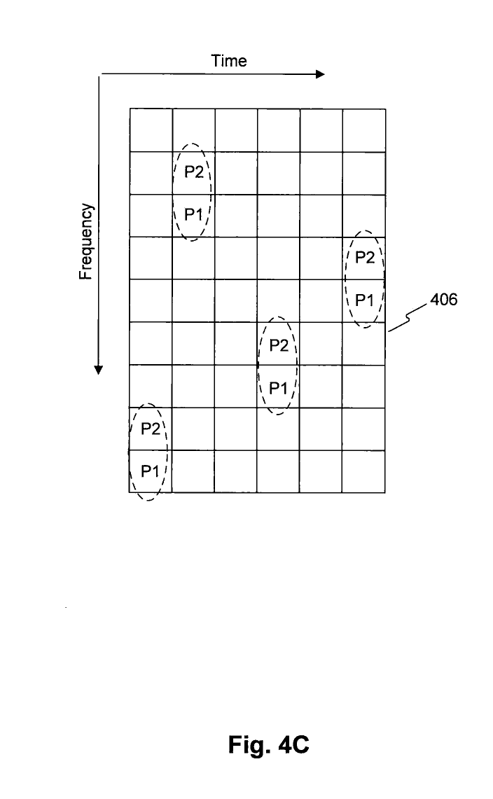

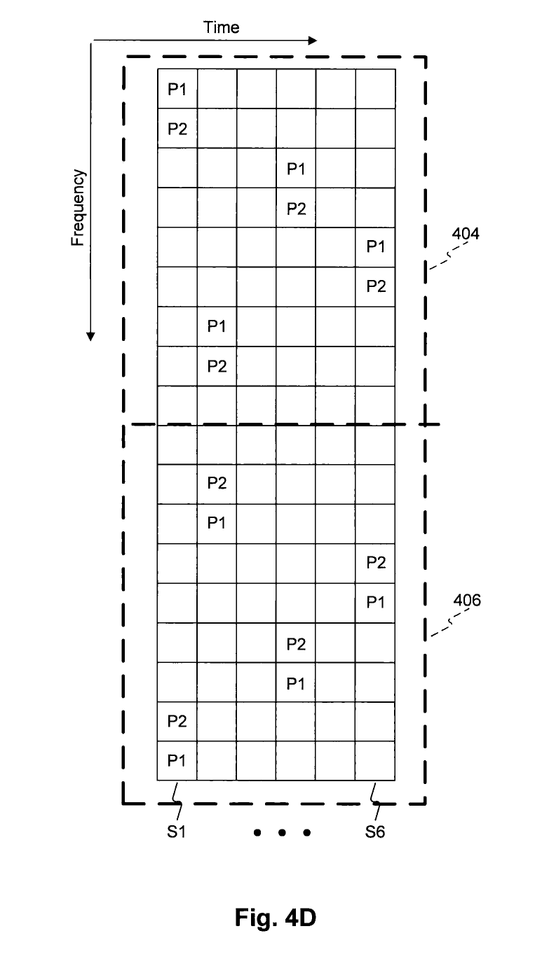

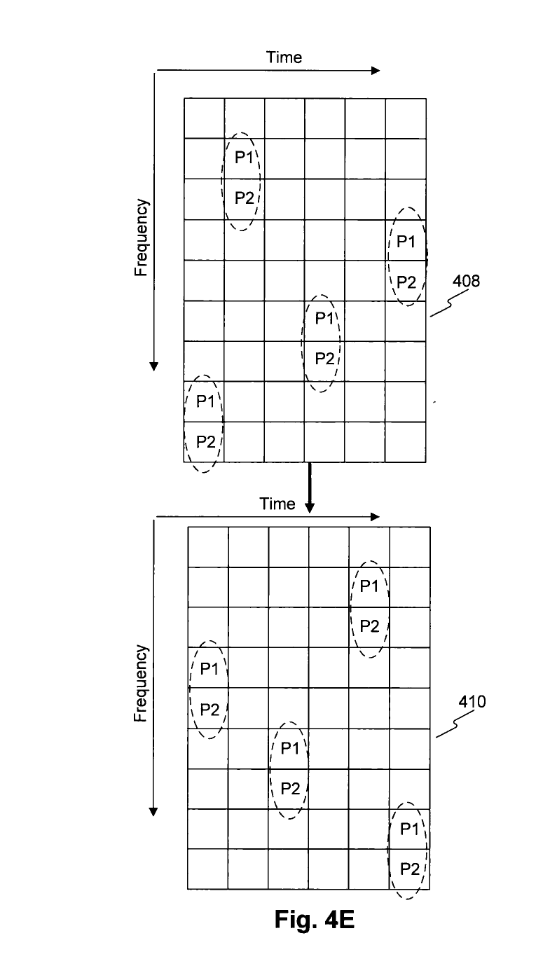

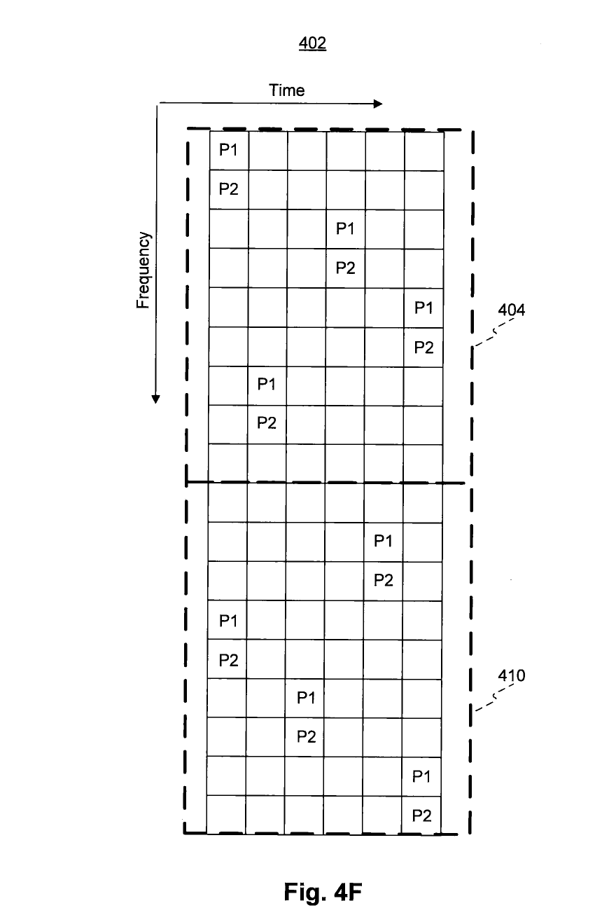

FIGS. 4A-4F illustrate an example of generating a pilot pattern using the method 200 (FIG. 2), according to an exemplary embodiment. For example, the pilot pattern is included in a resource block 402, and may be used in the above noted OFDM based communication system.

Referring to FIG. 4A, in the exemplary embodiment, the resource block 402 has a size of 18 subcarrier frequencies×6 OFDM symbols. Accordingly, a size of an exemplary basic resource unit for the resource block 402 may be determined to be, e.g., 9 subcarrier frequencies×6 OFDM symbols (FIG. 2, step 202).

More particularly, for the number of the subcarrier frequencies in the exemplary basic resource unit, 9 is a factor of the number of subcarrier frequencies in the resource block 402, i.e., 18. For the number of the OFDM symbols in the basic resource unit, 6 is a factor of the number of OFDM symbols in the resource block 402, i.e., 6.

FIG. 4B shows a generated basic resource unit 404 with the determined size of 9 subcarrier frequencies×6 OFDM symbols, according to an exemplary embodiment. For example, pilot symbols are allocated to the basic resource unit 404 to form a plurality of pilot clusters each encircled by a dashed line in FIG. 4B. Each of the pilot clusters includes a first pilot symbol P1 and a second pilot symbol P2 for the first data stream and the second data stream, respectively. As noted above, the allocation of the pilot symbols may be based on a predetermined pilot overhead constraint. As a result, the basic resource unit 404 is generated (FIG. 2, step 204).

Next, one or more variant resource units may be derived from the basic resource unit 404 (FIG. 2, step 206). For example, FIG. 4C shows a first variant resource unit 406. The first variant resource unit 406 is derived by performing, in frequency, a mirror operation of pilot symbols in the basic resource unit 404. Directly combining the basic resource unit 404 and the first variant resource unit 406 would result in a resource block with the intended size of 18 subcarrier frequencies×6 OFDM symbols, as shown in FIG. 4D. However, pilot symbols in the resultant resource block are distributed only in four of the six OFDM symbols, i.e., OFDM symbols S1, S2, S4, and S6, which may cause power fluctuation and, hence, degrade system performance.

As a result, referring to FIG. 4E, a second variant resource unit 408 is further derived by interchanging positions of the pilot symbols P1 and P2 within each cluster in the first variant resource unit 406. A third variant resource unit 410 is then derived by performing, in time, a mirroring operation of the pilot symbols in the second variant resource unit 408. The resource block 402 including the pilot pattern may then be generated by combining the basic resource unit 404 and third variant resource unit 410 (FIG. 2, step 206), as shown in FIG. 4F.

In exemplary embodiments, after a resource block is generated by combining a basic resource unit and one or more variant resource units, the generated resource block may be further modified. For example, after a resource block is generated by combining a basic resource unit and a variant resource unit, a location of a pilot symbol close to a border between the basic resource unit and the variant resource unit may be further adjusted after the combination.

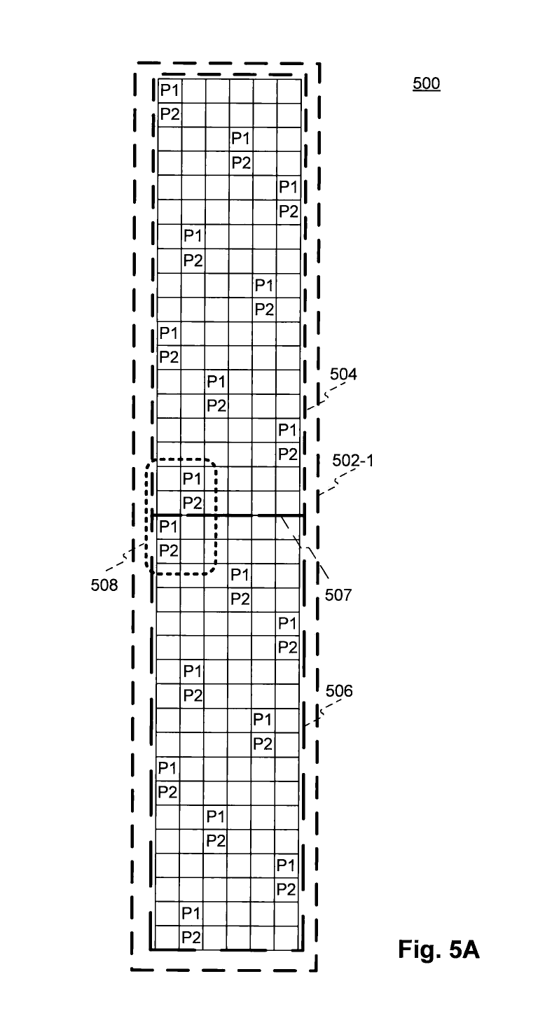

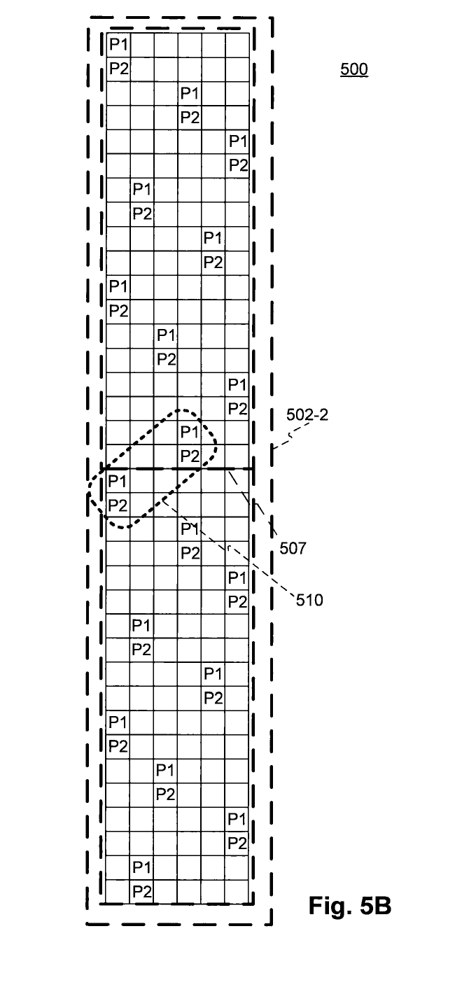

FIGS. 5A and 5B illustrate a method 500 for adjusting locations of pilot symbols close to a border between a basic resource unit and a variant resource unit, according to an exemplary embodiment. Referring to FIG. 5A, a resource block 502-1 for including a pilot pattern is generated by combining a basic resource unit 504 and a variant resource unit 506 which is the same as basic resource unit 504 in the exemplary embodiment, similar to the above description in connection with FIGS. 3D, 3E, and 4F. After the combination, the pilot symbols close to a border 507 between the basic resource unit 504 and the variant resource unit 506 are relatively crowded, as shown by a dashed circle 508 in FIG. 5A, which may degrade channel estimation performance. Accordingly, locations of ones of the pilot symbols close to the border may be adjusted, as shown by a dashed circle 510 in FIG. 5B. By using a resource block 502-2 after the adjustment as a pilot pattern, channel estimation performance may be improved.

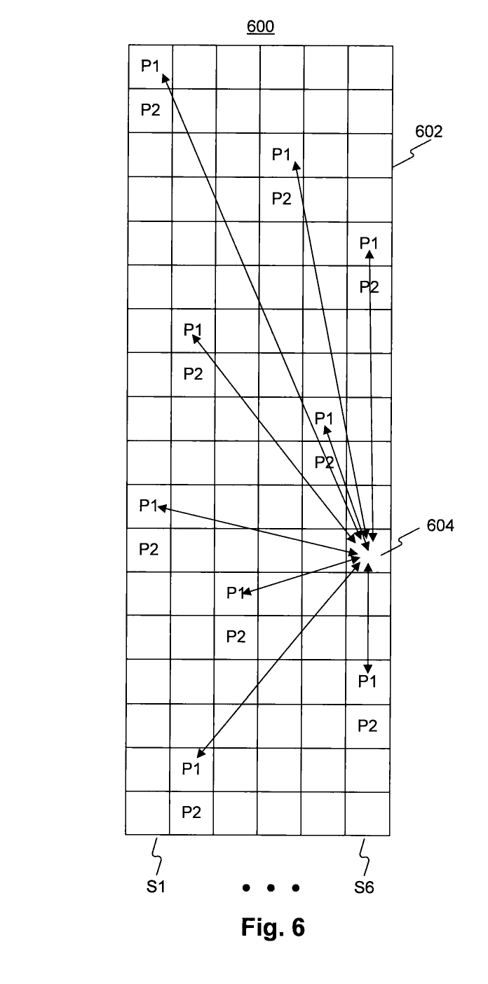

FIG. 6 illustrates a method 600 for generating a pilot pattern included in a resource block 602 for use in the above noted OFDM based communication system, according to an exemplary embodiment. Referring to FIG. 6, each row of the resource block 602 corresponds to a subcarrier frequency of the communication system, and each column of the resource block 602 corresponds to an OFDM symbol. In the exemplary embodiment, the resource block 602 includes a plurality of OFDM symbols such as OFDM symbols S1, . . . , S6, which further include a plurality of data symbols (not shown) each corresponding to a small blank block and a plurality of pilot symbols each represented by a small block with an indexed letter P. For example, the small blocks with indexed letters “P1” and “P2” represent pilot symbols for first and second data streams, respectively. In the resource block 602, each of the OFDM symbols S1, . . . , S6 is composed of one of the columns of data symbols and any pilot symbols included therein.

In exemplary embodiments, based on a linear minimum mean square error (LMMSE) channel estimation, optimum Wiener filter coefficients W_{D} for a data symbol corresponding to a small block 604 may be expressed as follows:

w_{D}=Rₚₚ⁻¹r_{pD}, equation (1)

where Rₚₚ is a channel correlation matrix with each element in Rₚₚ representing a channel correlation between two pilot symbols in the resource block 602, and r_{pD} is a channel correlation vector with each element in r_{pD} representing a channel correlation between the data symbol corresponding to the block 604 and one of the pilot symbols for a data stream, e.g., the first data stream, as shown by the double-headed arrows in FIG. 6. A resultant channel estimation mean square error (MSE) at the data symbol corresponding to the block 604 may be expressed as:

MSEₕ_{_{D}}=σₕ_{_{D}}²−r_{pD}^{H}Rₚₚ⁻¹r_{pD}, equation (2)

where σₕ_{_{D}}² is an average power of impulse response of a communication channel, which may be predetermined, and the superscript “H” denotes a conjugate operation.

In exemplary embodiments, based on the LMMSE channel estimation, pilot symbol locations may be determined by minimizing a sum of channel estimation MSEs at all data symbols in the resource block 602. For example, each element in Rₚₚ or r_{pD} may be expressed as follows:

r(Δt,Δf)=σₕ_{_{D}}²rₜ(Δt)r_{f}(Δf), equation (3)

where rₜ(Δt) and r_{f}(Δf) denote time and frequency correlation functions for two pilot/data symbols, respectively, Δt denotes a time difference between the two pilot/data symbols, and Δf denotes a frequency difference between the two pilot/data symbols. In one exemplary embodiment, rₜ(Δt) and r_{f}(Δf) may be further calculated as follows:

$${r}_{t} ( Δ t ) = \frac{sin ( 2 π {F}_{D} Δ t )}{2 π {F}_{D} Δ t} , \\ {r}_{f} ( Δ f ) = \frac{sin ( π Δ f {T}_{m} )}{πΔ f {T}_{m}} {e}^{- jπ Δ f {T}_{m}} , \qquad equation ( 4 )$$

where F_{D} is a Doppler frequency and Tₘ is a maximum delay spread, both of which may be determined or estimated by a receiver such as a mobile station. For example, a Doppler frequency is a parameter used to measure a signal frequency spread due to a change of a communication channel, the Doppler frequency indicating channel time variation that results from receiver mobility or change in communication environment. Also for example, a delay spread is a parameter used to measure an impulse response dispersion of a communication channel, the delay spread indicating a degree of multipath effects of the communication channel. By minimizing the sum of channel estimation MSEs at all data symbols in the resource block 602, where the channel estimation MSE at each of the data symbols may be determined based on equation (2), Rₚₚ and r_{pD} may be determined. As a result, pilot symbol locations in the resource block 602 may be further determined.

In exemplary embodiments, pilots symbol locations may also be determined by maximizing a sum of norm squares of channel correlation vectors

$${\sum }_{i} {‖ {r}_{pD} ‖}_{i}^{2} ,$$

each of the channel correlation vectors representing channel correlations between an i^{th} data symbol and the pilot symbols for a data stream in the resource block 602.

In exemplary embodiments, the above described methods for generating pilot patterns may be computer-implemented methods by using, e.g., a computer, an application specific integrated circuit (ASIC), or a digital signal processor (DSP), to implement. The generated pilot patterns may then be stored in the communication system for use. Alternatively, the above described methods may be implemented by the communication system in real-time.

As described above, the channel correlation vector r_{pD} may be determined by the time and frequency correlation functions rₜ(Δt) and r_{f}(Δf). Accordingly, the Doppler frequency F_{D} and the delay spread Tₘ may be used to adapt pilot patterns during communications. For example, based on different values of the Doppler frequency F_{D} and the delay spread Tₘ, different pilot patterns may be pre-generated based on the above equations. The generated pilot patterns may be indexed and stored in a base station in the communication system. When the base station communicates with a mobile station in the communication system, the base station may transmit to the mobile station information regarding a correspondence between the indexes of the pilot patterns and the values of the Doppler frequency E_{D} and the delay spread Tₘ. As a result, during communications, the communication system may adapt pilot patterns, as described below.

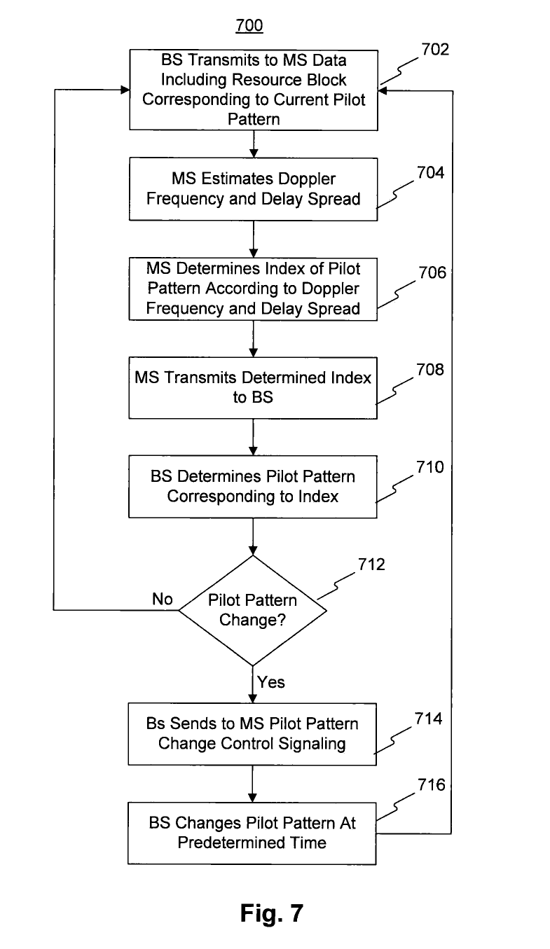

FIG. 7 illustrates a flowchart of a method 700 for an OFDM based communication system to adapt a new pilot pattern during communications, according to an exemplary embodiment. Referring to FIG. 7, a base station (BS) in the OFDM based communication system transmits to a mobile station (MS) in the OFDM based communication system data including a resource block corresponding to a current pilot pattern (702). Based on the resource block, the mobile station estimates a channel condition including, e.g., a Doppler frequency F_{D} and a delay spread Tₘ. The mobile station then determines an index of a pilot pattern to be adapted in accordance with the estimated Doppler frequency F_{D} and delay spread Tₘ (706), and transmits the determined index to the base station (708).

In exemplary embodiments, the base station determines a pilot pattern corresponding to the index received from the mobile station (710). The base station also determines if the pilot pattern corresponding to the index is the same as, or different from, the current pilot pattern (712). If the base station determines that the pilot pattern corresponding to the index is the same as the current pilot pattern (712—No), step 702 is repeated. Otherwise (712—Yes), the base station sends to the mobile station pilot pattern change control signaling to indicate a predetermined time for changing the current pilot pattern (714). When it is the predetermined time for changing the current pilot pattern, the base station adapts the new pilot pattern corresponding to the index received from the mobile station (716).

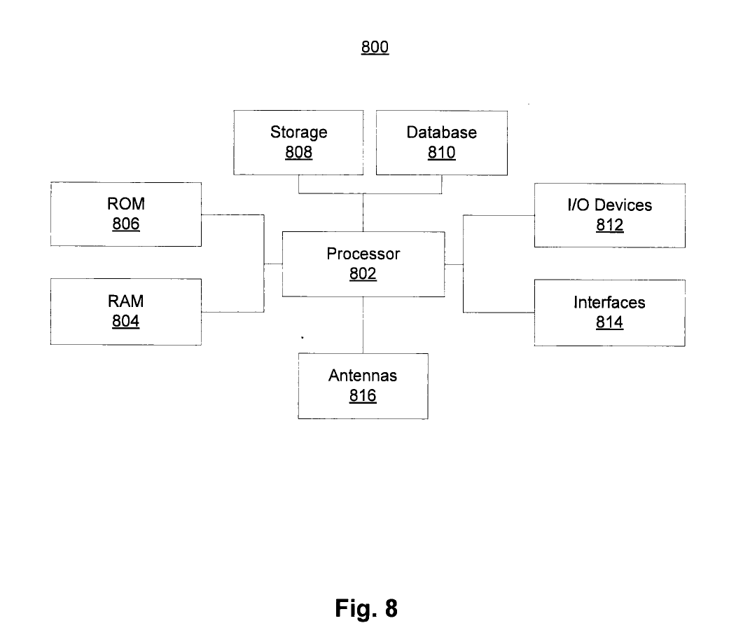

FIG. 8 illustrates a block diagram of a base station 800, according to an exemplary embodiment. Referring to FIG. 8, the base station 800 may include one or more of the following components: a processor 802 configured to execute computer program instructions to perform various processes and methods, random access memory (RAM) 804 and read only memory (ROM) 806 configured to access and store information and computer program instructions, storage 808 to store data and information, databases 810 to store tables, lists, or other data structures, I/O devices 812, interfaces 814, a set of antennas 816, etc. Each of these components is well-known in the art and will not be discussed further.

In one exemplary embodiment, in implementing the method 700 (FIG. 7), the set of antennas 816 is configured to transmit, to a mobile station, data including a current pilot pattern, and to receive, from the mobile station, a pilot pattern index determined by the mobile station, wherein the mobile station determines the pilot pattern index by estimating a channel condition between the base station 800 and the mobile station. The processor 802 is configured to determine a new pilot pattern based on the received pilot pattern index.

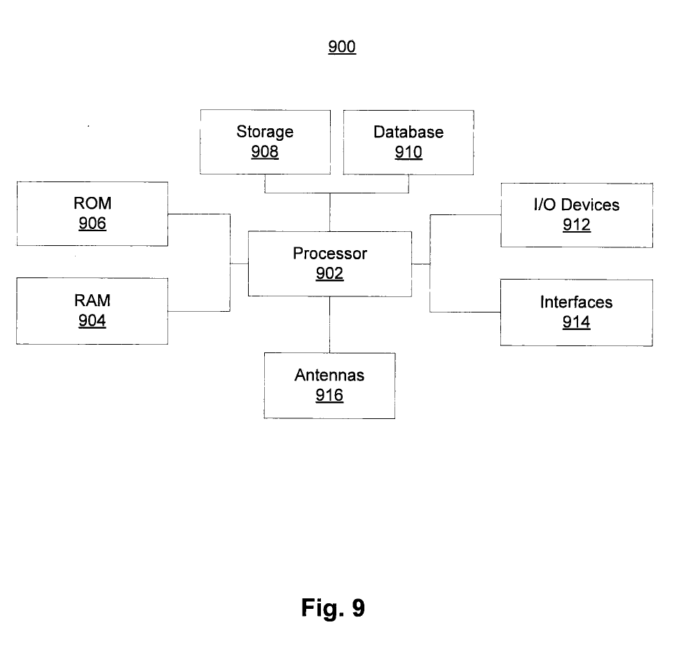

FIG. 9 illustrates a block diagram of a mobile station 900, according to an exemplary embodiment. For example, the mobile station 900 may include one or more of the following components: a processor 902 configured to execute computer program instructions to perform various processes and methods, random access memory (RAM) 904 and read only memory (ROM) 906 configured to access and store information and computer program instructions, storage 908 to store data and information, databases 910 to store tables, lists, or other data structures, I/O devices 912, interfaces 914, a set of antennas 916, etc. Each of these components is well-known in the art and will not be discussed further.

In one exemplary embodiment, in implementing the method 700 (FIG. 7), the set of antennas 916 is configured to receive from a base station data including a current pilot pattern, and the processor 902 is configured to estimate a channel condition between the base station and the mobile station 900 based on the current pilot pattern, and to determine an index for a new pilot pattern based on the estimated channel condition. The set of antennas 916 is further configured to transmit the index for the new pilot pattern to the base station in order for the base station to adapt the new pilot pattern.

Systems, devices, and methods may be implemented in a wireless communication system including a base station and a mobile station configured as the base station 800 (FIG. 8) and the mobile station 900 (FIG. 9), respectively.

While embodiments have been described based on two data streams, the invention is not so limited. It may be practiced with equal effectiveness with greater or fewer data streams.

While embodiments have been described based on an OFDM based communication system, the invention is not so limited. It may be practiced with equal effectiveness with other types of communication systems based on multiple subcarriers.

Other embodiments of the invention will be apparent to those skilled in the art from consideration of the specification and practice of embodiments disclosed herein. The scope of the invention is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A computer-implemented method for generating a pilot pattern for use in an orthogonal frequency-division multiplexing (OFDM) based communication system, the method comprising:
generating a basic resource unit to which a plurality of pilot symbols are allocated, each of the pilot symbols corresponding to a subcarrier frequency and an OFDM symbol;
deriving one or more variant resource units from the basic resource unit; and
combining ones of the basic resource unit and the one or more variant resource units to generate a resource block including the pilot pattern.

2. The method of claim 1, wherein the pilot symbols are allocated to the basic resource unit to form a plurality of pilot clusters, each of the pilot clusters including first and second pilot symbols for first and second data streams, respectively.

3. The method of claim 1, wherein generating the basic resource unit comprises:
determining that the basic resource unit includes a first number of subcarrier frequencies and a second number of OFDM symbols, the first number being a factor of a number of subcarrier frequencies included in the resource block, and the second number being a factor of a number of OFDM symbols included in the resource block.

4. The method of claim 1, wherein deriving a first one of the variant resource units comprises:
interchanging positions of first and second ones of the pilot symbols in the basic resource unit, the first and second ones of the pilot symbols for first and second data streams, respectively.

5. The method of claim 1, wherein deriving a first one of the variant resource units comprises:
moving a first one of the pilot symbols from a first location in the basic resource unit to a second location in the basic resource unit, the first and second locations being symmetrical in time or in frequency.

6. The method of claim 1, wherein deriving a first one of the variant resource units comprises:
performing, in time or in frequency, a cyclic shift of the pilot symbols in the basic resource unit.

7. The method of claim 1, further comprising:
modifying the resource block after the combining.

8. A computer-implemented method for generating first and second pilot patterns for use in an orthogonal frequency-division multiplexing (OFDM) based communication system, the method comprising:
generating a basic resource unit to which a plurality of pilot symbols are allocated, each of the pilot symbols corresponding to a subcarrier frequency and an OFDM symbol;
deriving one or more variant resource units from the basic resource unit;
combining ones of the basic resource unit and the one or more variant resource units to generate a first resource block including the first pilot pattern; and
combining ones of the basic resource unit and the one or more variant resource units to generate a second resource block including the second pilot pattern.

9. The method of claim 8, wherein the pilot symbols are allocated to the basic resource unit to form a plurality of pilot clusters, each of the pilot clusters including first and second pilot symbols for first and second data streams, respectively.

10. The method of claim 8, wherein generating the basic resource unit comprises:
determining that the basic resource unit includes a first number of subcarrier frequencies and a second number of OFDM symbols, the first number being a common factor of a number of subcarrier frequencies included in the first resource block and a number of subcarrier frequencies included in the second resource block, and the second number being a common factor of a number of OFDM symbols included in the first resource block and a number of OFDM symbols included in the second resource block.

11. The method of claim 8, wherein deriving a first one of the variant resource units comprises:
interchanging positions of first and second ones of the pilot symbols in the basic resource unit, the first and second ones of the pilot symbols for first and second data streams, respectively.

12. The method of claim 8, wherein deriving a first one of the variant resource units comprises:
moving a first one of the pilot symbols from a first location in the basic resource unit to a second location in the basic resource unit, the first and second locations being symmetrical in time or in frequency.

13. The method of claim 8, wherein deriving a first one of the variant resource units comprises:
performing, in time or in frequency, a cyclic shift of the pilot symbols in the basic resource unit.

14. The method of claim 8, further comprising:
modifying at least one of the first resource block and the second resource block.

15. A computer-implemented method for generating a pilot pattern for use in an orthogonal frequency-division multiplexing (OFDM) based communication system, the method comprising:
determining locations of pilot symbols in a resource block including the pilot pattern, such that a sum of channel estimation mean square errors (MSEs) at all data symbols in the resource block is minimized.

16. A computer-implemented method for generating a pilot pattern for use in an orthogonal frequency-division multiplexing (OFDM) based communication system, the method comprising:
determining locations of pilot symbols in a resource block including the pilot pattern, such that a sum of norm squares of channel correlation vectors may be maximized, wherein each of the channel correlation vectors represents channel correlations between one data symbol and a plurality of pilot symbols for a data stream.

17. A method for a base station to adapt a new pilot pattern, the method comprising:
transmitting, to a mobile station, data including a current pilot pattern;
receiving, from the mobile station, a pilot pattern index determined by the mobile station, wherein the mobile station determines the pilot pattern index by estimating a channel condition between the base station and the mobile station; and
determining the new pilot pattern based on the received pilot pattern index.

18. A base station, comprising:
a set of antennas configured to transmit, to a mobile station, data including a current pilot pattern, and to receive, from the mobile station, a pilot pattern index determined by the mobile station, wherein the mobile station determines the pilot pattern index by estimating a channel condition between the base station and the mobile station; and
a processor configured to determine a new pilot pattern based on the received pilot pattern index.

19. A method for a mobile station to assist a base station to adapt a new pilot pattern, comprising:
receiving, from the base station, data including a current pilot pattern;
estimating a channel condition including a Doppler frequency or a delay spread between the base station and the mobile station, based on the current pilot pattern;
determining an index for a new pilot pattern based on the estimated channel condition; and
transmitting the index for the new pilot pattern to the base station in order for the base station to adapt the new pilot pattern.

20. A mobile station, comprising:
a set of antennas configured to receive from a base station data including a current pilot pattern; and
a processor configured to estimate a channel condition including a Doppler frequency or a delay spread between the base station and the mobile station, based on the current pilot pattern, and to determine an index for a new pilot pattern based on the estimated channel condition;
wherein the set of antennas is further configured to transmit the index for the new pilot pattern to the base station in order for the base station to adapt the new pilot pattern.

21. A base station for generating a pilot pattern for use in an orthogonal frequency-division multiplexing (OFDM) based communication system, the base station comprising:
a processor, the processor being configured to:
generate a basic resource unit to which a plurality of pilot symbols are allocated, each of the pilot symbols corresponding to a subcarrier frequency and an OFDM symbol;
derive one or more variant resource units from the basic resource unit;
combine ones of the basic resource unit and the one or more variant resource units to generate a resource block including the pilot pattern.

22. A base station for generating first and second pilot patterns for use in an orthogonal frequency-division multiplexing (OFDM) based communication system, the base station comprising:
a processor, the processor being configured to:
generate a basic resource unit to which a plurality of pilot symbols are allocated, each of the pilot symbols corresponding to a subcarrier frequency and an OFDM symbol;
derive one or more variant resource units from the basic resource unit;
combine ones of the basic resource unit and the one or more variant resource units to generate a first resource block including the first pilot pattern; and
combine ones of the basic resource unit and the one or more variant resource units to generate a second resource block including the second pilot pattern.
